(19) United States
(12) Patent Application Publication
(10) Pub. No.: US 2007/0146557 A1
(43) Pub. Date: Jun. 28, 2007

(54) Fixing mechanism

(76) Inventors: Kuo-Yuan Chang, Chu-Nan (TW); Wei-Cheng Huang, Chu-Nan (TW)

Correspondence Address: J.C. Patents, Inc., Suite 250, 4 Venture, Irvine, CA, 92618, US

(21) Appl. No.: 11/413,399

(22) Filed: Apr. 28, 2006

(30) Foreign Application Priority Data
Dec. 12, 2005 (TW) 94221637

(51) Int. Cl. H04N 5/74

(52) U.S. Cl. 348/782

(57) ABSTRACT

A fixing mechanism suitable for fixing a reflective mirror on a base plate of a rear projection TV is provided. The fixing mechanism comprises first fixing members, second fixing members and cushions. The first fixing members are arranged on the base plate to restrain the movement of the reflective mirror along a first direction. The first fixing member comprises a body and fixing parts connected to the body. The reflective mirror is placed within the fixing part of the first fixing member by the cushions. The second fixing members are arranged on the base plate to restrain the movement of the reflective mirror along a second direction, wherein an included angle is formed between the first direction and the second direction. The second fixing members cover a portion of the reflective mirror.

### CROSS-REFERENCE TO RELATED APPLICATION

This application claims the priority benefit of Taiwan application serial no. 94221637, filed on Dec. 12, 2005. All disclosure of the Taiwan application is incorporated herein by reference.

### BACKGROUND OF THE INVENTION

1. Field of the Invention

The present invention generally relates to a fixing mechanism, and more particularly, to a fixing mechanism adapted for fixing a reflective mirror of a rear projection TV.

2. Description of Related Art

FIGS. 1A and 1B show a conventional rear projection TV 10 comprising four fixing members 12 adapted for fixing four edges of a reflective mirror 13, and each fixing part 12 is a Y shape strip structure. When assembling, an anti-scrape film (not shown) is attached to the edges of the reflective mirror 13 by using adhesives, and then the reflective mirror 13 is placed in the groove 12a of the fixing part 12. Next, the fixing members 12 are screwed to a base plate 11 by the screws 14, such that the reflective mirror 13 is fixed on the base plate 11.

However, the fixing members 12 are heavy, and therefore the rear projection TV 10 increases in weight. Furthermore, the fixing members 12 and the reflective mirror 13 are both made of rigid material, and therefore a gap exists between the reflective mirror 13 and the groove 12a of the fixing members 12. The reflective mirror 13 may collide with the fixing members 12 during transportation, which may crack the reflective mirror 13. Therefore, a surface of the reflective mirror 13 is fixed on the inner surface of the fixing members 12 with glue to solve the above-mentioned problem. However, the residual glue may remain on the fixing members 12 or the reflective mirror 13 during replacement of the fixing members 12 or the reflective mirror 13, and this results in an unlikelihood to use the fixing members 12 or the reflective mirror 13 repeatedly. In addition, the residual glue may also remain on the anti-scrape film attached to the reflective mirror 13, and accordingly the reflective mirror 13 can not be reused.

### SUMMARY OF THE INVENTION

Accordingly, the present invention is provided for a fixing mechanism adapted for fixing a reflective mirror on a base plate of a rear projection TV, to lower the occurrence of cracks in the reflective mirror and improve the reusability of the reflective mirror by resolving the problems due to the residual glue.

The present invention is provided for a fixing mechanism suitable for fixing a reflective mirror on a base plate of a rear projection TV. The fixing mechanism comprises two first fixing members, two second fixing members and a plurality of cushions. The first fixing members are arranged on opposite sides of the base plate respectively, to restrain the movement of the reflective mirror along a first direction. Each first fixing part comprises a body and a fixing part connected to the body, wherein the fixing part and the body are integrally formed. The fixing part is composed of a plurality of first side walls and at least one second side wall. The reflective mirror is disposed between the first side walls and the second side wall. The second fixing members are disposed on the base plate, respectively, to restrain the movement of the reflective mirror along a second direction, wherein an included angle is formed between the first direction and the second direction. Each second fixing member covers edges portion of the reflective mirror. In addition, a plurality of cushions is disposed between the first side wall and the second side wall of each first fixing member. The shape of the cushions can be a U-shape, and the cushions can be made of rubber. The reflective mirror is wedged in the cushions. The fixing mechanism further comprises a plurality of fixing screws arranged on the first fixing members and the second fixing members, respectively, for fixing the first fixing members and the second fixing members on the base plate.

The fixing mechanism of the present invention utilizes the fixing members for fixing the reflective mirror on the base plate of the rear projection TV and the cushions for clamping the reflective mirror, such that the occurrence of cracks in the reflective mirror can be lowered during transportation. Besides, compared with the prior art, the weight of the fixing mechanism is lower. Furthermore, the cushions are wedged in the first fixing members, and they utilize the design of a U-shape structure to clamp the reflective mirror instead of the conventional glue. Therefore, when the reflective mirror or the cushions are damaged or misplaced, it is easier to replace them. Additionally, there is no residual glue remaining on the reflective mirror or the cushions, such that reusability can be improved which would be helpful to rework.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram showing a conventional rear projection TV.

FIG. 1B is a schematic diagram showing a fixing member shown in FIG. 1A.

FIG. 2 is a schematic three-dimensional exploded drawing of a rear projection TV utilizing a fixing mechanism of the present invention.

FIG. 3 is a schematic three-dimensional exploded drawing of the fixing mechanism of the present invention.

FIG. 4A is a schematic diagram showing a first fixing member before bonding.

FIG. 4B is a schematic diagram showing a first fixing member.

FIG. 5 is a schematic cross-sectional view showing a reflective mirror and a cushion wedged in the first fixing member.

FIG. 6 is a schematic three-dimensional drawing showing a second fixing member of the present invention.

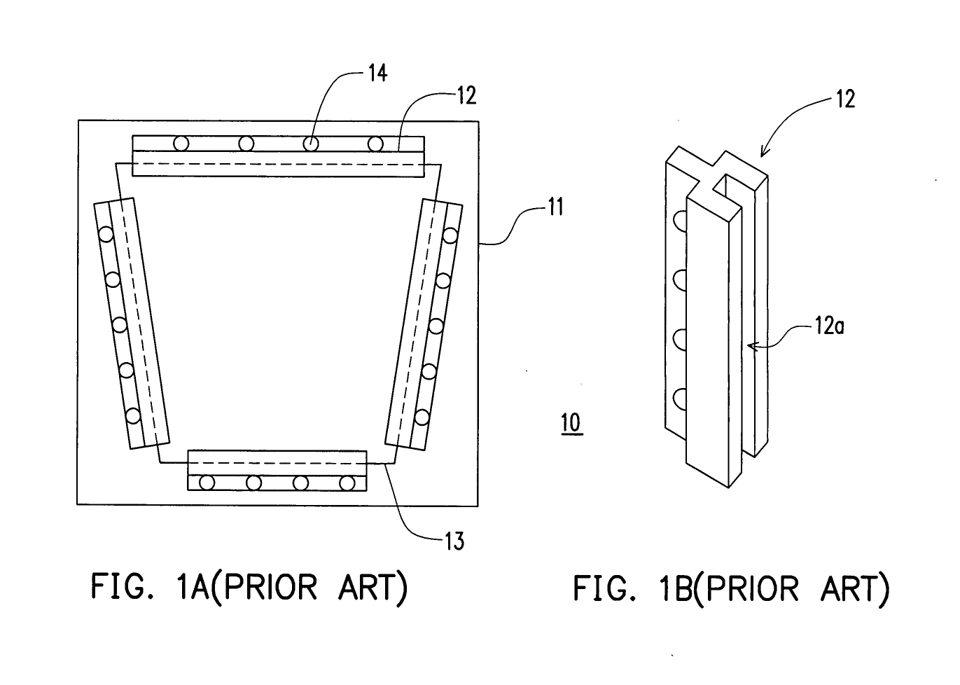

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

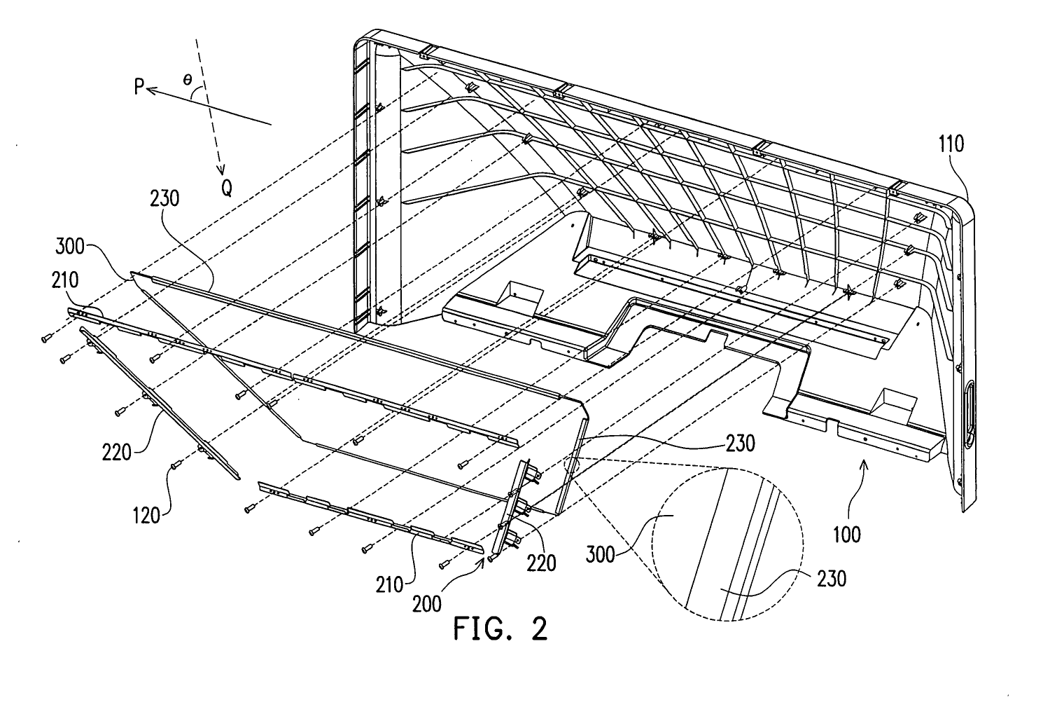

Referring to FIG. 2, a fixing mechanism 200 of the present invention is suitable for fixing a reflective mirror 300 on a base plate 110 of a rear projection TV 100. The fixing mechanism 200 comprises two first fixing members 210, two second fixing members 220 and a plurality of cushions 230.

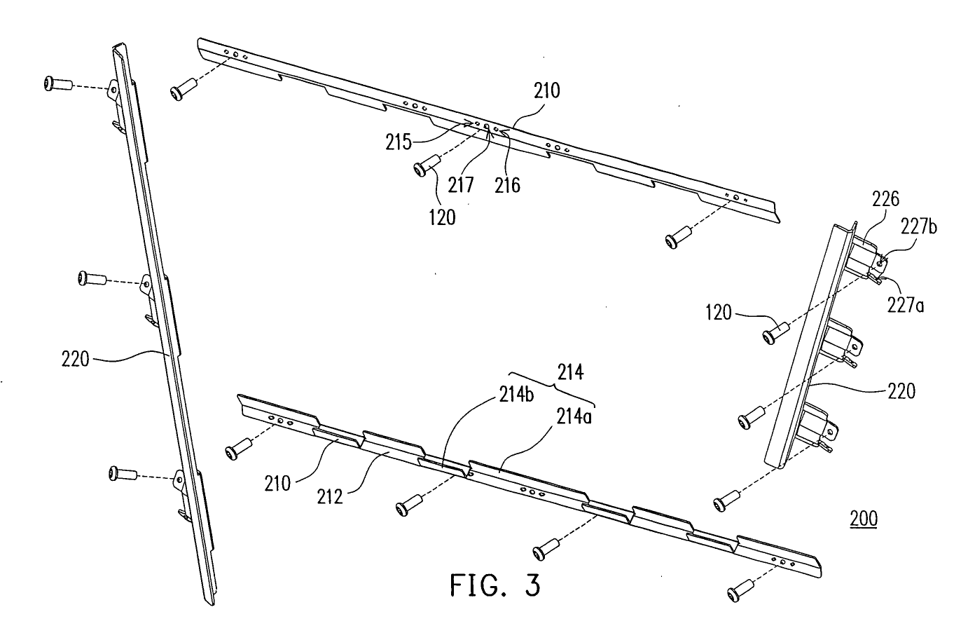

Referring to FIGS. 2 and 3, the first fixing members 210 are arranged on opposite sides of the base plate 110. In this embodiment, the first fixing member 210 are arranged of the upper side and the lower side of the base plate 110, and each first fixing member 210 comprises a body 212, fixing parts 214 connected to the body 212 and holes 215, 216 and 217. The fixing parts 214 and the body 212 are integrally formed. The fixing part 214 comprises a first side wall 214a and a second side wall 214b. The first side wall 214a is connected to the body 212, and one side of the second side wall 214b is connected to the first side wall 214a, and the other side of the second side wall 214b is separated from the first side wall 214a by a distance. The cushions 230 are wedged between the first side wall 214a and the second side wall 214b. The first side wall 214a and the second side wall 214b are alternatively arranged. In other words, a second side wall 214b is arranged between every two adjacent of the first side wall 214a.

It should be noted that the fixing parts 214 utilizes a plurality of first side walls 214a and a plurality of second side walls 214b wherein each second side wall 214b is arranged between every two adjacent of the first side walls 214a, to fix the cushions 230. However, the first side walls 214a and the second side walls 214b may have different arrangement. For example, the fixing part 214 may only comprise two first side walls 214a and a second side wall 214b, to make the wedged cushions 230 in the fixing part 214.

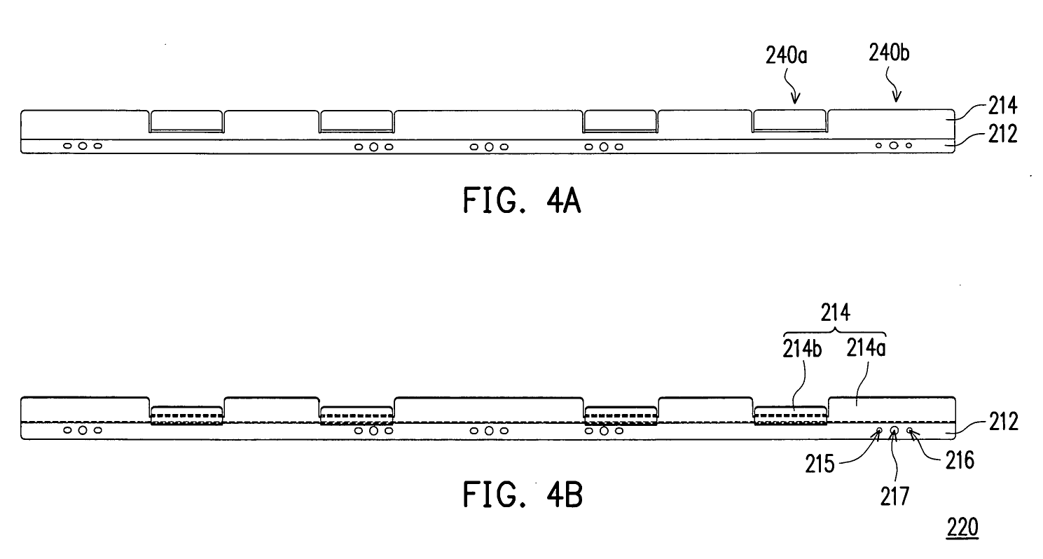

Referring to FIGS. 4A and 4B, more specifically, the first fixing member 210 of the present invention may be made of metal, and the method of fabricating the first fixing member 210 may include bending a metal sheet along a longer side to form all L-shape structure such that the body 212 and the fixing part 214 are formed. Then, the fixing part 214 is divided into two regions 240a and 240b (as shown in FIG. 4A). Next, the region 240a of the fixing part 214 is bended to form the second side wall 214b, and the region 240b which is not bended forms the first side wall 214a (as shown in FIG. 413). In addition, the first fixing member 210 is fixed on the positioning protrusion (not shown herein) of the base plate 110 by the holes 215 and 216, and fixing screws 120 pierce through the hole 217 to make the first fixing member 210 be screwed on the base plate 110.

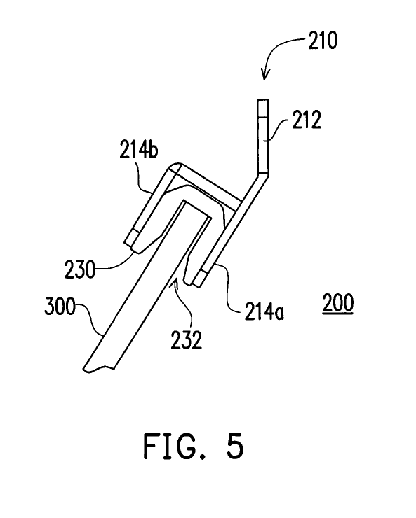

Referring to FIGS. 2, 3 and 5, the cushions 230 are arranged within the first fixing member 210 and in the gap formed between the first side wall 214a and the second side wall 214b of the fixing part 214. In this embodiment, the cushions 230 can be made of rubber. The cushion 230 is a strip structure having a groove 232 and has a cross-section of U-shape. Besides, the edges of the reflective mirror 300 are clipped by the two free ends of the U-shape cushions 230, such that the reflective mirror 300 is fixed in the groove 232. When designing the cushions 230, the maximum thickness of the cross-section of the cushion 230 is slightly larger than a distance between the first side wall 214a and the second side wall 214b. Additionally, the first side wall 214a and the second side wall 214b of the first fixing member 210 are elastic, such that the cushion 230 having the U-shape and is made of rubber can be wedged between the first side wall 214a and the second side wall 214b when assembling.

When the reflective mirror 300 is assembled with the first fixing member 210, the cushion 230 can provide a buffering effect such that the reflective mirror 300 is not directly in contact with the first fixing member 210. Accordingly, the possibility of cracking of the reflective mirror 300 during transportation can be reduced. Moreover, the cushion 230 is wedged in the first fixing member 210, and it utilizes the U-shape structure to clamp the reflective mirror 300 instead of using the glue. Accordingly, when the reflective mirror 300 or the cushions 230 are damaged or misplaced, it is easier to replace the reflective mirror 300 or the cushions 230. Furthermore, the problems due to residual glue on the reflective mirror 300 or the cushions 230 can be effectively avoided, and therefore the reusability can be increased which is helpful to rework.

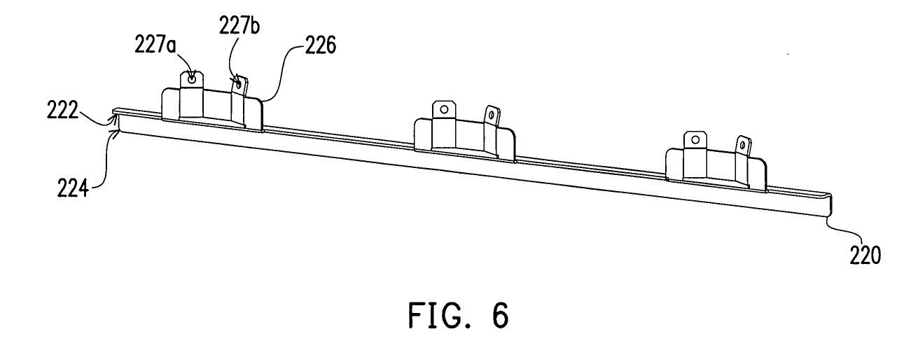

Referring to FIGS. 2, 3 and 6, the second fixing members 220 are arranged on opposite sides of the base plate 110 where the first fixing members 210 are not arranged thereon. In this embodiment, the second fixing members 220 are arranged on the left side and the right side of the base plate 110, and each second fixing member 220 can be an L-shape structure made of metal. The second fixing member 220 has a bottom surface 222, a supporting surface 224, a screwing part 226 and two screwing holes 227a and 227b disposed on the screwing part 226. The screwing holes 227a and 227b are corresponding to the fixing holes on the left side and the right side of the base plate 110, respectively. The screwing holes 227a and 227b are symmetric along a direction which is perpendicular to the longer side of the second fixing member 220, such that the second fixing member 220 having the same specification can be used on the left side and the right side of the base plate 110. This arrangement would significantly reduce the number of the components and reduce manufacturing cost, and the assembly of the components can be implemented quickly and with case. The reflective mirror 300 is leaned against the bottom surface 222 and the supporting surface 224 of the second fixing member 220, and then the fixing screws 120 pass through the screwing holes 227a at and 227b to fix the second fixing member 220 to the base plate 110.

The assembly of the reflective mirror 300 on the base plate 110 of the rear projecting TV 100 is illustrated in the following. First, the opposite sides of the reflective mirror 300 are wedged in the groove 232 of the cushions 230, and then the cushions 230 are placed between the first side walls 214a and the second side walls 214b of the first fixing member 210. Next, the fixing screws 120 pass through the holes 217 to fix the first fixing members 210 on the base plate 110, and thereby restrain the movement of the reflective mirror 300 along a first direction Q. Then, two other opposite sides of the reflective mirror 300 are lent against the bottom surfaces 222 and the supporting surfaces 224 of the second fixing members 220. The second fixing members 220 are fixed on the base plate 110 by passing the fixing screws 120 through the screwing holes 227a and 227b, and thereby restrain the movement of the reflective mirror 300 along a second direction P, where an angle θ is formed between the first direction P and the second direction Q. Thus, the reflective mirror 300 is fixed on the base plate 110 of the rear projection TV 100 by using the first fixing members 210 and the second fixing members 220.

According to the above description, the cushions 230 can be placed within the second fixing members 220 for providing a buffer effect such that crackling of the reflective mirror 300 of the rear projection TV 100 due to external impact during transportation may be avoided. In other words, the four edges of the reflective mirror 300 are clipped by the cushions 230. When the rear projection TV 100 falls or is impacted during transportation, the cushions 230 can absorb the impact force, to protect the reflective mirror 300.

Compared with the conventional fixing members of Y-shape structure, the fixing member of L-shape structure of the present invention can reduce components required, and therefore the weight of the rear projection TV is reduced. In additional, the cushions are arranged between the fixing members and the reflective mirror to reduce the cracks of the reflective mirror during the transportation.

It will be apparent to those skilled in the art that various modifications and variations can be made to the structure of the present invention without departing from the scope or spirit of the invention. In view of the foregoing, it is intended that the present invention cover modifications and variations of this invention provided they all within the scope of the following claims and their equivalents.

1. A fixing mechanism, suitable for fixing a reflective mirror on a base plate of a rear projection television, comprising:
two first fixing members arranged on opposite sides of the base plate respectively, wherein each first fixing part comprises a body and a fixing part connected to the body, and the fixing part is adapted for securing an edge of the reflective mirror;
two second fixing members arranged on another opposite sides of the base plate respectively, wherein each second fixing member is adapted for securing an edge of the reflective mirror; and
a plurality of cushions wedged in the fixing parts respectively and being clipped to the reflective mirror.

2. The fixing mechanism according to claim 1, wherein the fixing part comprises a plurality of first side walls and at least one second side wall, the first side walls are connected to the body, one side of the second side wall is connected to the corresponding first side wall, the other side of the second side wall is separated from the corresponding first side wall by a distance, and each cushion is wedged between the first side wall and the second side wall.

3. The fixing mechanism according to claim 2, wherein a part of the fixing part is bent to form the second side all.

4. The fixing mechanism according to claim 1, wherein the fixing part and the body are integrally formed.

5. The fixing mechanism according to claim 1, wherein the cushions comprise strip structures and have a U-shape cross-section, and the educes of the reflective mirror are clipped by two free ends of the cushions.

6. The fixing mechanism according to claim 1, wherein each cushion comprises rubber.

7. The fixing mechanism according to claim 1, further comprising, a plurality of fixing screws arranged on the first fixing members and the second fixing members, such that the first fixing members and the second fixing members are fixed oil the base plate.

8. The fixing mechanism according to claim 1, wherein the first fixing members and the second fixing members comprise metal.

9. The fixing mechanism according to claim 1, wherein the second fixing members comprise L-shape structures.

10. The fixing mechanism according to claim 1, wherein the second fixing members are arranged on a left side and a right side of the base plate respectively, a screwing part of each second fixing member has two screwing holes corresponding to the fixing holes on the left side and the right side of the base plate, respectively.
